(19) United States
(12) Patent Application Publication
(10) Pub. No.: US 2022/0174242 A1
(43) Pub. Date: Jun. 2, 2022

(54) SMART MIRROR ARCHITECTURE

(71) Applicant: Robert E. Culver, II, Akron, OH (US)

(72) Inventor: Robert E. Culver, II, Akron, OH (US)

(21) Appl. No.: 17/531,412

(22) Filed: Nov. 19, 2021

Related U.S. Application Data
(60) Provisional application No. 63/119,679, filed on Dec. 1, 2020.

(51) Int. Cl. H04N 7/18; H04N 5/225; H04N 5/232; H04N 1/32; H04M 1/02; A47G 1/02

(52) U.S. Cl. CPC H04N 7/183; H04N 5/2257; H04N 5/23203; H04M 2250/52; H04N 1/32374; H04M 1/0264; A47G 1/02; H04N 7/188

(57) ABSTRACT

A smart mirror (and imaging) system which enables a user to view themselves in the mirror of the system while separately capturing self-images when positioned within the viewing capability of a camera employed in combination with the mirror system. The mirror system can be sufficiently sized for carrying in a purse, in a laptop computer carrying case, a brief case, and/or a piece of carry-on luggage for air travel. The mirror system can be configured with volatile onboard memory to automatically lose the onboard data when the mirror system power is removed or dropped.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed is a “smart” mirror architecture (includes camera and processor enhancements) in a personal formfactor (e.g., sizes typically associated with handheld devices such as mobile telephones, personal digital assistants (PDAs) (also known as handheld personal computers), tablet computers, notebook computers, and even larger dimensioned devices sized similar to portable and desktop computer displays, etc.) that can more readily be purchased and transported (e.g., carried by the user) for utilization in user spaces and locations such as residences, hotel/motel rooms, vehicles, and so on.

In more robust implementations, the smart mirror architecture finds applicability to larger systems where the smart mirror approaches sizes in dimensions of several feet such as a freestanding floor mirror of five feet vertical height or more (e.g., six to seven feet vertical height).

The smart mirror architecture is a structured collection of hardware and/or software which enables a mirror housing to receive and support an imaging system that can be controlled to capture images of animate and inanimate objects (e.g., a user, an item, etc.). The image capture function can be self-initiated and directed at the user thereby triggering capture of the image (oftentimes referred to a “selfies”) and/or by other techniques (e.g., programmed) or persons.

In another implementation, the image capture function can be automatically triggered based on interpretation of detected (sensed) data, such as the dwell in time of the user in front of the camera. In other words, rather than initiating a countdown of eight seconds, which is commonly employed in traditional systems, the user can set in software that camera image capture should execute a predetermined number of seconds after the person dwells substantially motionless in front of the camera for a sufficient amount of time. For example, when a user steps in front of the image capture system, and stays sufficiently motionless for three seconds (as detected within certain motion parameters and computed by the camera system and software), the camera executes image capture.

The image capture process can be the triggering event for several subsequent processes or events. For example, once an image is captured, user profile selections can cause execution of automatic transfer of the image to a different destination. This transfer-to-a-different-destination process can then be the trigger to wipe the memory of the camera system so that no information is retained by the smart mirror system when being used in a public setting for use by the general public. This thereby protects personal information of one user from being exposed to another user who is not authorized to perceive such personal information.

This transfer process can also trigger at least one subsequent process that validates the transfer is accomplished without any errors, thereby ensuring that transferred data is stored and valid, before initiating a wipe operation of the camera. This process can be employed on any destination device or source, such as cloud storage, flash drive storage, cell phone storage, disk drive storage, and so on. This validation process can also be employed where data is retained on the camera, but yet transferred to another location for storage.

The imaging system can employ off-the-shelf cameras (e.g., manufactured by the GOPRO™ company) of a size suitable for placement inside the atypical smaller housings which employ the various dimensions above for personal use, carrying, and other purposes. Such cameras can be sufficiently small in dimensions such as palm-size cameras, the smaller “miniature” cameras (smaller than palm-size), and so on.

In another implementation, other devices which employ cameras, such as mobile telephones (also “cell(ular) phones” or “mobile phones”), can be received into the smart mirror housing and positioned to capture images.

It is also within contemplation of the disclosed architecture that multiple suitable cameras can be mounted in the housing in compatible holders, positioned at view-through apertures, and triggered to capture images through the apertures (or portals). For example, three imaging systems can be employed to capture a panoramic view in front of the smart mirror housing.

More specifically, the three cameras can each capture image portions within the viewing constraints of the respective cameras. Software can then be employed to automatically stitch the three captured images together to then provide a single seamless panoramic view of the scene in front of the housing front panel. This stitching process finds image edge commonalties between adjacent images such that detected image fragments of two adjacent images can be overlayed to then provide a single larger image that presents both the smaller images but as a single seamless image presentation.

Multiple imaging systems can be employed within the housing and multiple interior camera holders such that any one or more of the hosted camera systems can be oriented in different ways to capture correspondingly different scenes. For example, a top interior camera can be oriented slightly downward in the vertical plane to capture images in a downward facing scene, a center camera under the top camera can be oriented to capture straight-ahead scenes, and a bottom interior camera can be orient in tis holder to oriented slighting in an upward direction of the vertical plane to capture slightly upward scenes. Such holder orientation can be achieved using slides, locking nuts, and other commonly known mechanisms in the art.

In one embodiment, the camera does not retain captured images and user-identifiable information in a memory when powered off. Thus, the camera(s) comprise only volatile memory. In another embodiment, the camera contains non-volatile memory, but upon transmission of the image (stored in the non-volatile memory) and potentially metadata (e.g., timestamp data, user name, location data, geolocation data, etc.), to another location, software instructions cause the image and other related data to be deleted after storage at the other location is confirmed. These instructions can be stored (“hard-coded”) and executed in the camera, such as by an ASIC (application-specific integrated circuit) chip in the camera, for example. The ASIC can be customized to perform a particular function (e.g., use) rather than a general-purpose function.

Alternatively, these instructions are executed by the other location to cause deletion of the images in the camera (also known as “wiping the memory”). This function can be accomplished alternatively by a “reset” function of the camera, which when executed, wipes the camera memory and returns the camera software to a previous state.

In yet another implementation, the camera can be mounted to the mirror system housing, but on the outside of the housing, rather than inside the housing. In either or both of the housing mountings (inside, outside), the images (and potentially other data), can be stored on a “thumb” drive that connects to the camera. The thumb drive can be considered a remote storage location relative to the camera, since image/data storage is not in the memory of the camera case but on a mass storage device connected to the camera via the camera case or housing.

In order to access the inside of the mirror system housing, the front panel can be latched and hinged on one side (e.g., long side, short side, etc.) to enable the user to unlatch the front panel to gain access to the internal volume and housing to place a camera in a holder provided therein, and then close the front panel and latch the panel to secure the panel and camera within.

The disclosed smart mirror architecture can be used as a standard mirror simply for reflective image purposes. Since, in one implementation, the mirror does not comprise the capability to store captured images on the camera, these images can be stored directly to a micro-drive device such as a flash memory USB drive and thereafter downloaded directly into a device (e.g., cell phone) photo album and/or to social media account(s).

There can be provided a time delay (e.g., five to ten seconds) to allow the user the ability to press a “start” or “go”-type button on the cell phone to start a process, for example, and then pose, without the user needing to hold the cell phone.

The imaging system of the mirror can also be configured to sync (or synchronize) (transfer data/settings to or from) with the cell phone and/or camera, a smart watch, and/or other smart dress items such as smart shoes, to take a “selfie”.

The mirror system can also employ a small attachment apparatus (e.g., a clip-on, suction cup, etc.) to enable attachment of the imaging system (camera) to a surface and/or placement of the camera into a holder-type housing.

The imaging system can be portable and employ a USB port and SIM card port, and hardware/software which enables syncing of the images to a software application. In one implementation, the camera (imaging) system can approximate four (4) inches in length, 0.287 inches in depth (or thickness), and 1.5 inches width.

In addition to providing the hardware/software capability to push a captured image from the imaging system to another device, or pull a captured image from the imaging system using another device, the smart mirror system can receive a previously-captured image and present the image via the imaging system and/or present the previously-captured image onto all or part of the front panel for viewing.

It can be the case that a user cell phone can auto-link (automatically connect) to a smart mirror, wherever the smart mirror is located. For example, if a salon, barbershop, etc., has a smart mirror for each grooming/treatment alcove, or at least one smart mirror for public use, a user can auto-connect to the business smart mirror system as though it was a personal smart mirror from home. This is because, in one implementation or configuration, no user data (e.g., personally identifiable data) is allowed to be stored on the imaging system of the smart mirror.

A software capability provided by the imaging system enables the capability to “pair” (e.g., create an established data connection using a passkey) a device (e.g., a cell phone) to the imaging system, which establishes a link (e.g., Bluetooth™) for data exchange or transfer. In other words, in one implementation, when the device comprises a camera, pairing of the imaging system to the device bypasses the device camera subsystem and thereby establishes the link between only the device (communications and control subsystems) and the smart mirror imaging system. Thus, the device camera system is offline insofar as data and signal communications between the paired device and smart mirror.

In another implementation, a linking function enables access to some or all capabilities of a linked device. For example, if the linked device is a cell phone, some or all image capture aspects could be made compatible with the cell phone software and hardware systems for further processing such as image enhancement, coloration, resolution, and so on.

In one embodiment, a mirror system is disclosed herein, comprising: a housing having an internal volume within a front panel and a back panel, the front panel comprises a reflective surface to function as a mirror to an object positioned in front of the front panel; an imaging system mounted within the housing for capturing an image of the object; an aperture in the front panel through which the imaging system captures the image of the object; and a data connection in the housing for transmission and storage of the captured image from the imaging system to a remote storage.

The imaging system can lack a non-volatile storage subsystem in which to store the captured image. The mirror system can further comprise multiple imaging systems mounted within the housing and from which correspondingly multiple images are transmitted and stored in the remote storage.

The remote storage can be part of a mobile telephone configured to receive the image from the imaging system. The mirror system can further comprise a holder mounted within the housing, which holder is compatible for receiving a mobile telephone and using a camera of the mobile telephone for image capture of the object.

The imaging system can execute functions in response to user interactions interpreted by the imaging system. The imaging system can execute instructions and/or functions in response to non-contact user interactions interpreted by the imaging system, the non-contact user interactions comprise at least one of user vocalizations or user gestures.

The imaging system can connect to and be controlled by a mobile telephone and be controlled according to imaging system instructions received from the mobile telephone. The mirror system can further comprise a presentation system which presents media on the front panel, with which media a user can interact. The imaging system can delete user-specific data when powered off or as a step to perform before powering off the imaging system.

The imaging system can be automatically configured according to instructions received from a system external to the housing. The mirror system can be a hand-held system.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a frontal view of an implementation of a smart mirror system in accordance with the disclosed features.

FIG. 2 illustrates a view of the smart mirror system with the front panel partially removed and offset from the front of the housing.

FIG. 3 illustrates a view of the smart mirror system connected to the device.

FIG. 4 illustrates a block diagram of a smart mirror system in accordance with the disclosed architecture.

FIG. 5 illustrates a block diagram of a computing system capable of interfacing to and processing smart mirror data and settings in accordance with the disclosed architecture

### DETAILED DESCRIPTION

Disclosed is a personal smart mirror (and imaging system) which enables a user to view themselves in the mirror of the system while separately capturing self-initiated-images (“selfies”) while positioned within the camera viewing capability of a camera employed in combination with the mirror system. The personal smart mirror architecture can be designed as a publicly accessible system whereby any user can interact with the system capabilities and functions based on a purchase basis.

Existing mirror systems comprise two commercial grade mirrors and which enable picture taking. One existing system has a camera attached to the top edge of the traditional mirror (include a reflective back layer under an overlying glass front surface) and another existing system works only with a connected iPhone™. Moreover, the existing systems are dominantly commercial implementations, which are neither sufficiently small nor able to be used in many desirable places such as a home, bathroom, shop, etc., or further, to include widespread application compatibility.

In contrast, the disclosed innovative smart mirror system is a new style mirror system which employs a camera behind a transparent (e.g., glassed) or substantially transparent front panel or reflective surface. The smart mirror can be used by individuals, stylists, barbers, makeup artists, etc., to capture “selfie” images (e.g., pictures), selfie videos, other types of (“selfie”) media and content, etc., of their activity (e.g., work). Thus, the disclosed smart mirror architecture enables media capture and presentation (e.g., in real-time, delayed, etc.) that provides the desired camera angle and unencumbered shot without having to struggle for the right angle, check the lighting, address shot blocking interference such as by an arm in the way, and so on.

The mirror system can be constructed to any size with the media capture system (e.g., a camera, multiple cameras positioned at different locations, etc.). The smart mirror system can also be constructed to accommodate a border, frame, or without, and even customized according to the glass dimensions and geometric shapes (e.g., rectangular, elliptical, circular, etc.).

The smart mirror system can also employ hardware and/or software capability which enables linking to other devices as well as the smart mirror, such as a smartphone, tablet computer, desktop computer, LAN (local area network), PAN (personal area network). Thus, one smart mirror system can communication wirelessly and/or by wire to another smart mirror system, directly and/or via such networks capture images, create videos, and merge capture media from multiple different smart mirror systems nearby and/or remote.

Accordingly, the smart mirror system can employ short-range wireless communication technologies such as Bluetooth™, for example, to sync/link to another mirror system at a remote location such as a salon shop, bars, clubs, work areas, vacation areas, etc.

In another feature, the smart mirror system employs a small mirror subsystem suitably sized and with sufficient capability to accommodate a camera subsystem, and potentially other subsystems such as a transceiver subsystem, storage subsystem, power subsystem, control subsystem, and so on, which enables a standalone mirror system to operate and be user operated without another computing device or power.

In a more robust implementation, the smart mirror subsystem communicates with an off-mirror computing device to offload processing and command execution predominantly by the off-mirror device(s)/system(s).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. The intention is to cover all modifications, equivalents, and alternatives falling within the spirit and scope of the claimed subject matter.

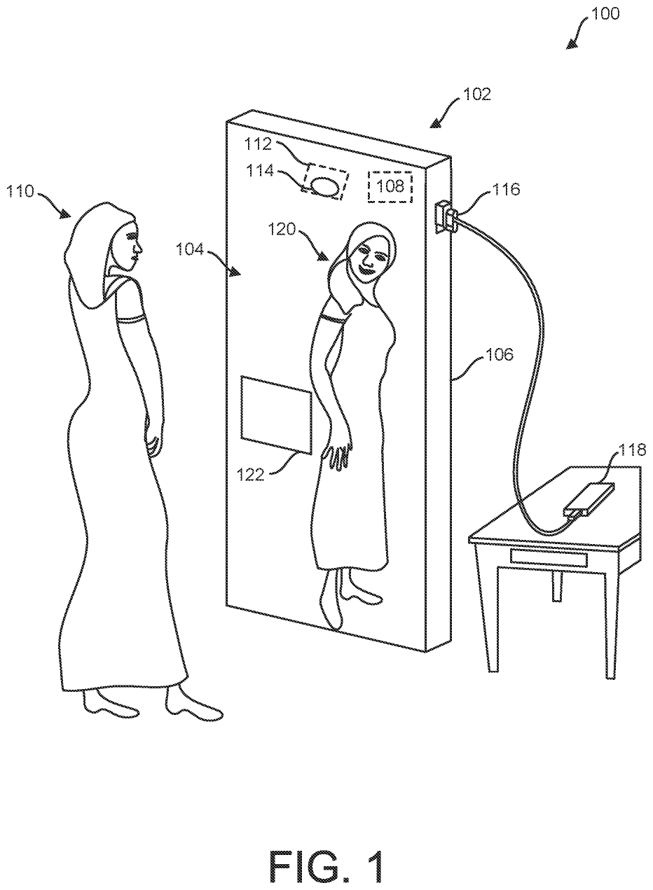

FIG. 1 illustrates a frontal view of an implementation of a smart mirror system 100 in accordance with the disclosed features. The mirror system 100 can comprise a housing 102 (in this example implementation, shaped as a rectangular box having a front panel 104, a back panel 106, and multiple side panels, which circumscribe an internal volume 108 (the label designated with a dashed line to represent the volume internal to the housing 102).

The front panel 104 can be an outwardly-facing mirror having a reflective surface (proximate the internal volume 108) and which functions as a mirror to an object 110 (e.g., a user, users, pets, etc., and other animate and inanimate objects) positioned in front of the front panel 104.

The reflective surface 106 can be constructed of a transparent material (e.g., glass, plastic, etc.) and a reflective material (e.g., a spray-on coating, painted-on coating, oven-baked coating, etc.), the design similar to conventional mirrors. Thus, the front panel 104 (also, the “forward-facing side” of the six-sided rectangular housing 102) comprises the transparent material (e.g., glass), and a reflective coating on the inside (or backside) surface of the transparent material, such that object light reflects off the object 110, through the transparent material, off the reflective coating (or material), and back to the object 110.

An imaging system 112 (illustrated as a dashed-line block) can be mounted behind the front panel 104 and within the internal volume 108. In one implementation, the imaging system 112 can be mounted on the backside surface of the front panel 104 (the backside surface facing the internal volume 108). In other words, the imaging system 112 can be mounted on the inwardly-facing side of the front panel 104 proximate the reflective coating. Alternatively, the imaging system 112 (e.g., camera) can be mounted on the inside surface of the back panel 106 of the housing 102, where the inside surface of the back panel 106 is the inwardly-facing surface to the internal volume 108. Thus, in this alternative implementation, the imaging system 112 does not contact the inwardly-facing side of the front panel 104.

The mirror system 100 can further comprise at least one aperture 114 in the front panel 104 (the mirror) through which the imaging system 112 captures the image of the object 110. In one implementation, the aperture 114 is a through-hole cut through the front panel 104 and through which the camera of the imaging system has an unobstructed view of the object 110. In an alternative implementation, the imaging system 112 captures the object 110 through an entirely transparent portion of the front panel 104, which is the aperture 114, and which transparent portion has the reflective material removed, but retrains the mirror glass (or plastic material). In any case, in one implementation, the aperture 114 is suitably sized so as to not be distracting to the person using and in front of the smart mirror system 100.

The mirror system 100 can further comprise a physical data/signal connection 116 in the housing 102 for at least the transmission and storage of the captured image of the object 110 from the imaging system 112 to a device 118 (e.g., a remote storage of a cell phone). The physical connection 116 can also accommodate signals and instructions that facilitate the enablement of other features of the disclosed imaging architecture.

Although depicted as a physical connection (e.g., cable and connector(s)) for data and signal communications between the housing 102 and the device 118, it is to be understood that data and/or signal communications can be attained via wireless connectivity, alternatively, or in combination with the physical connection.

The imaging system 112 can be provided to lack an onboard storage subsystem in which to store the captured image(s). Thus, any image captured by the imaging system 112 is immediately transmitted to the device 118, rather than being temporarily stored on the imaging system 112, and then transmitted. In this way, user information (e.g., where the object 110 is a user) is not subject to exposure to another user who may use the mirror system 100 thereafter.

Alternatively, the mirror system 100 can further comprise multiple imaging systems 112 mounted within the housing 102 and from which correspondingly multiple images are captured from various angles through corresponding apertures (not shown) and, transmitted and stored in the device 118. Thus, this capability can offer to the user multi-dimensional views which can then be stitched/overlapped together by software for any desired purpose.

The device 118 can be part of any storage-capable device (e.g., a standalone flash drive, the storage subsystem as part of a cell phone, the storage subsystem as part of a handheld computing device, etc.) outside the housing 102 (e.g., part of a cell telephone) configured to receive the image from the imaging system 110.

The imaging system 112 can be mounted in a holder (a structure suitable for receiving and securing an imaging-capable device, and/or a device incorporating an imaging subsystem) which is compatible for receiving a cell phone using a cell phone camera for image capture of the object 110 as an object image 120.

The imaging system 112 can be configured to execute functions in response to user interactions interpreted by the imaging system 112 and associated subsystems. The user interactions can comprise at least one of vocalizations or gestures. Thus, the user can vocalize voice commands to control operability of the imaging system 112, and/or generate gestures using body movements (e.g., hand movements, arm movements, body movements, eye and facial movements, combinations and sequences of gestures and movements that cause a specific function to occur, etc.).

The imaging system 112 can be connected to and controlled by (hardware and/or software of) a cell phone and controlled according to imaging system instructions received from the cell phone. Alternatively, the imaging subsystem 112 can be configured to connect to a thumb drive on which a self-executing or user-initiated program controls the imaging system 112 to access and store images from the imaging system 112.

The mirror system 100 can further comprise a presentation system 122 which presents media (e.g., image, video, text, etc.) on all or part of the (outwardly-facing surface) front panel 104 (the mirror).

The imaging system 112 can be controlled to delete user-specific data when powered off. Thus, if the user operates the imaging system 112 according to a user profile, the operating instructions and settings implemented will not be retained by the imaging system 112. Essentially, the imaging system 112 operates under a “reset” command which wipes the imaging system 112 of any existing data and/or instructions back to its factory settings, thereby removing all user information and settings. Thus, upon start-up (e.g., power-up) the imaging system 112 can be automatically configured according to instructions stored outside the imaging system 112. In this way, a user profile can be loaded into the imaging system 112 to operate according to the specific user.

The imaging system 112 can be as small as a hand-held system, rather than existing systems that are prohibitively large and cumbersome at least insofar as system moving and mobility is concerned. Moreover, the mirror system 100 can be sufficiently sized for carry in a purse (male or female), in a laptop computer carrying case, a brief case, and a piece of carry-on luggage for air travel, for example.

In an alternative implementation, rather than device 118 being solely a remote storage, or the storage associated with a cell phone, for example, device 118 can be a charger that provides power to the imaging system 112 and other internal subsystems (not shown) that could be implemented in or with the housing 102.

As previously indicated, the device 118 can be a smart phone which interfaces to the imaging system 112 to accomplish the desired results (image capture and storage (local or remote)). As a cell phone, the device 118 can then operate installed software to process features via a voice-activated interface, gesture interface, etc., for example.

As a wireless-capable communications device, device 118 can provide wireless connectivity to onboard smart mirror subsystems, rather than via a physical cable connection, or via both wired and wireless connectivity. Thus, a pairing function can be automatically initiated when the user comes in range of the smart mirror.

Additionally, where multiple imaging systems 112 can be employed, the system 102 can offer a multi-dimensional (e.g., 2-D, 3-D, etc.) output of images. Moreover, where the aperture is sized according to the camera capabilities, the image output can be panoramic, for example. If the standard imaging system 112 is not so capable to sense multiple different inputs such as audio, video, or to output media presentation, the connected device 118 can be so equipped to provide these capabilities.

In one implementation, the front panel 104 (the mirror) can also support HUD (heads-up display) capability where information can be displayed and perceived (e.g., viewed) by a user. Moreover, the smart mirror system 100 can also be designed to include audio speakers on the left side and/or right side, via which music media can be played. The smart mirror system 100 can also employ backlighting behind the front panel 104 such that selected colored lighting is provided in the interior volume 108, and some of which the specific lighting is viewable by the user in front of the front panel 104.

In a more robust implementation, front panel 104 is itself a display which presents any media normally associated with standard display function of laptop computers, notepad computers, desktop computers, etc. In such an implementation, the mirror object (e.g., selfie) can be captured by the imaging system 112, communicated to the display subsystem, and then overlayed on the background media displayed (e.g., image, video, text, music video, etc.) on the display (now, the front panel 104). Thus, as a presentation-type mirror surface, media received (e.g., from any sending system such as smart cell phone, phone carrier, computing system, etc.) can be presented on the display while the user interacts with the smart mirror system 100.

Moreover, technology can be employed to move presented information to the foreground or the background based on the type of information. For example, if the user is waiting for a phone call, and the connected phone is muted, the call data can be presented in the foreground when received, or in a specific area of the front panel 104. In this sense, the front panel 104 functions as a heads-up display (HUD).

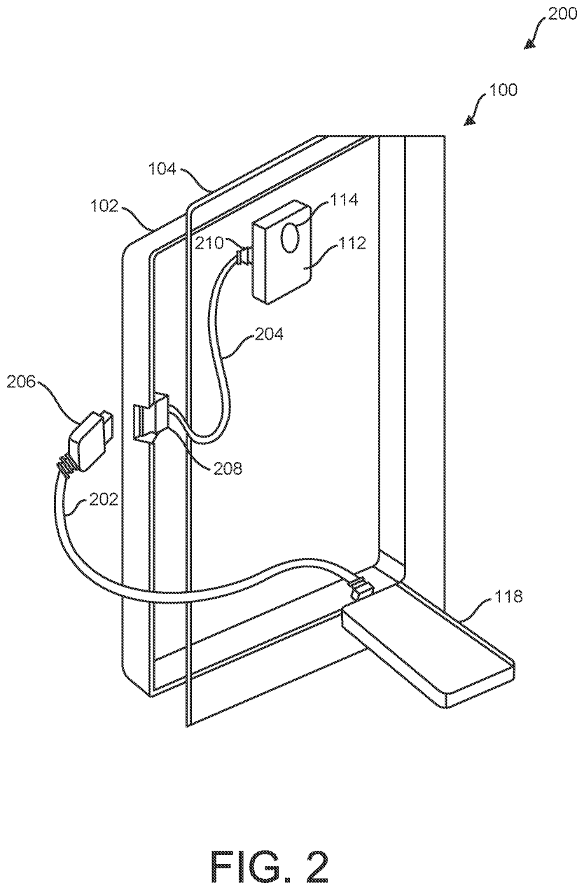

FIG. 2 illustrates a view 200 of the smart mirror system 100 with the front panel 104 partially removed and offset from the front of the housing 102. The overall reduced size of the mirror system 100 is limited based only on the size of the hardware employed inside the housing 102 and/or along the sides to provide interface access to interior subsystems. Here, the mirror of the front panel 104 is shown substantially transparent to view cables (e.g., external cable 202 and internal cable 204) and imaging system 112 internal to the housing 102.

The camera lens of the imaging system 112 is depicted as aligned to the aperture 114 so as so be able to capture images in front of the front panel 104 when triggered to do so. The hardware also depicts compatible mating connectors (206 and 208) which enable connection of the internal cable 204 and imaging system 112 to the external cable 202 and ultimately to the device 118, as well as a connector 210 compatible with connecting to the image system 112. For example, the cabling/connector system can be a USB configuration (e.g., USB A, B, C, etc.) or any other suitable cable/connector system for the intended purposes.

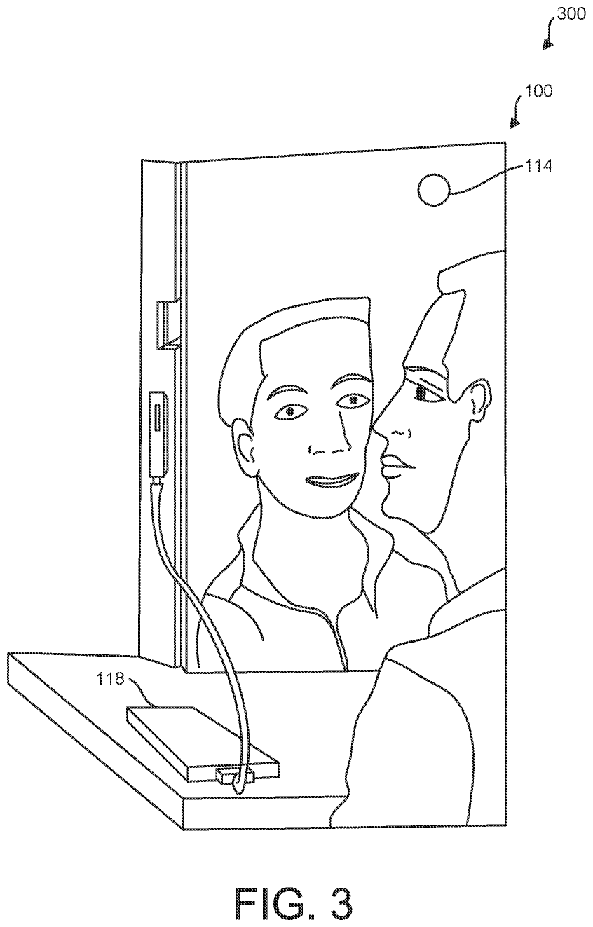

FIG. 3 illustrates a view 300 of the smart mirror system 100 connected to the device 118. In one implementation, operating as a self-enabled (bootable) system, once the device 118 (e.g., as a power supply) is connected to the mirror system 100 (and the internal imaging system 112), the smart mirror automatically operates (e.g., boots up) to capture images of object(s) in front of the front panel 104 and automatically download and store images from the imaging system 112 to an external storage system (e.g., the device 118).

It can be an implementation that the device 118 functions as both a power supply and storage system, such that connection of the device 118 to the mirror system 100 automatically triggers the imaging system 112 to begin capturing images. In this instance, the user simply moves in front of the mirror system 100, until image capture is no longer desired, and then disconnects the device 118.

In an alternative implementation, connecting the power supply/storage system device 118 to the mirror system 100 powers the imaging system 112 to prepare for image capture. Included in this implementation can be a sensor that detects when the user/object moves in front of the front panel 104, and signals the imaging system 112 to begin capturing images and downloading the captured images to the external storage component of the device 118. Once movement is no longer detected, for example, in front of the mirror system 100, the sensor signal is processed to stop image capture by the imaging system 112. The one or more sensors which can be employed for this implementation can be a motion sensor which detects motion and/or a proximity sensor which detects a change in distance relative to the front panel 104.

The trigger enabling circuit can alternatively be a timer which automatically counts down from eight seconds after power is applied by the device 118, after which begins the capture and download of images to the device 118.

In yet another implementation, once the device 118 is connected to the mirror system 100, a user profile can be uploaded and processed to initialize the imaging system according to settings the user prefers most often. In another implementation, when the device 118 is connected to the mirror system 100, a user profile is processed by the device 118 and settings of the imaging system 112 are adjusted in response.

For a dual-purpose device 118 of storage and power supply, the device 118 can provide power to the imaging system 112, and include a connector for connecting a thumb drive to the device 118 for image storage on the thumb drive.

Where the device 118 is a smart cell phone, a software application can be installed on the cell phone which provides a user interface for interacting with camera features and settings. Such software features are limited only by the features of the imaging system camera employed. In other words, the software may be designed to interface to many different kinds of imaging systems 112 and associated functions/controls/features, which can be utilized in the mirror system 100. The software can be designed to automatically wipe (delete from) the imaging system of all data and settings so that another user cannot access such personal information.

Thus, the smart mirror system 100 boots up and waits to operate according to the phone software. The software can be designed for many different feature controls such as enabling the user-capture of self-images, providing a multi-second delay so the user can get into place for the capture, etc. No user content is stored on the mirror system 100. Thus, if the mirror system 100 breaks or is stolen, no user data is lost on the mirror system.

In contrast to the imaging system being wiped of data and settings to avoid personal user information being snooped, alternatively, any data captured in the imaging system 112 (such as on a SIM (subscriber identification module) card) can be encrypted, momentarily secured by password (e.g., user-assigned, auto-assigned, phone-assigned (where device 118 is a cell phone), etc.). Thus, encrypted user data can be downloaded to the external user system so the data cannot be snooped.

In a more robust implementation of the mirror system 100, the system 100 can configured to be an endpoint according to IoT (Internet of things) technology. The mirror system 100 can also be designed to connect (e.g., wirelessly via Bluetooth, WiFi, etc.) to smart speaker systems such as ECHO™ by Amazon Corporation and also interface (e.g., wirelessly via Bluetooth, WiFi, etc.) to an intelligent personal assistant (software that performs tasks for a user in response to voiced questions or commands) such as ALEXA™ by Amazon Corporation. The disclosed system 100 can also find applicability to linking to any suitable wireless devices such as watches and other personal devices that can be worn in combination with smart garments (garments having wireless devices sewed or constructed therein).

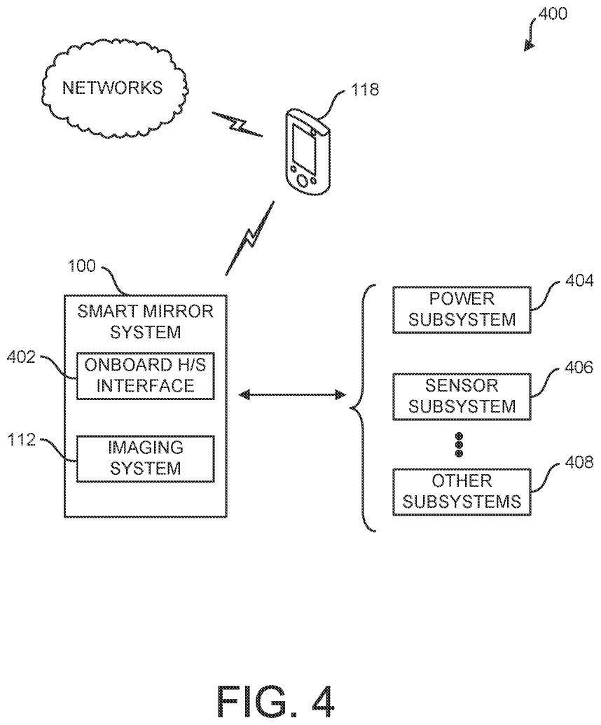

FIG. 4 illustrates a block diagram 400 of a smart mirror system 100 in accordance with the disclosed architecture. The smart mirror system 100 can comprise the housing 102, an onboard (as part of the smart mirror housing 102) hardware/software (H/S) interface component 402 and at least one onboard imaging system 112.

The smart mirror system 100 can further be constructed with a power subsystem 404 which provides power to the smart mirror system 100 and any other onboard systems, such as the imaging system 112. The power subsystem 404 can also connect to external power systems, such as a standalone battery system, and/or the power system of the device 118, which can be a cell phone. In this embodiment, the image system 112 can further comprise the sole power subsystem 404 which facilitates the receipt of power from an external power source.

The smart mirror system 100 can also comprise a sensor subsystem 406, which includes one or more sensors that enhance utilization of the smart mirror system 100. For example, a sonic sensor can be provided to detect the distance of an object in front of the mirror (the front panel 104). Another sensor can be a motion sensor which detects motion of the object in front of the mirror. Another sensor can be a microphone which receives voice signals from a person in front of the mirror. Yet another sensor set can be speakers which output audio media. Other sensors can include and sense light sensitivity, imaging processing of user gestures (audio, vocal, body gestures, facial gestures, hand and appendage gestures, etc.).

Put another way, there is disclosed a mirror system, comprising: a housing having an internal volume within a front panel and a back panel, long side panels, and short side panels, the front panel comprises a reflective surface which functions as a mirror to an object positioned outside the internal volume and in front of the front panel; an imaging system mounted within the housing for capturing an image of the object via an aperture of the front panel, the imaging system operating according to instructions for configuring, capturing, transmitting, and storing the image; and a data connection for transmission of at least the image from the imaging system and storage of the image in an external storage.

The external storage of the mirror system can be is part of a cellular phone. The data connection can be at least one of wired or wireless capable. The imaging system can be part of a handheld camera that operates according to the instructions, and that can be installed and removed from the housing.

The imaging system can be part of cellular phone, which cellular phone is manually inserted in the housing and the imaging system of the cellular phone is installed in alignment with the aperture. User commands received by the cellular phone can be processed to operate the imaging system of the phone according to the instructions.

Operation of the imaging system can be automatically executed in response to at least one user gesture or combinations of user gestures (e.g., two-fingered display, two-handed movements, etc.).

The imaging system can be automatically triggered in response to detection of the object. In another implementation, conditions related to the object and time of image capture can be measured (and sensed) and stored as image metadata. The imaging system can employ volatile memory wherein a captured image is immediately transmitted from the imaging system to a remote storage location, and then erased from the imaging system.

The imaging system can be controlled by a remote device to initiate image capture, which image capture further initiates creation of metadata related to the image capture, and transmission of the captured image and metadata to the remote device. The mirror system can further comprise a presentation system, which presents media on all or part of the front panel, and with which media a user can interact. In one implementation, part of the front panel functions as a heads-up display to present information to the user.

The imaging system can retrieve a previously stored image from a remote device and present the image for viewing via the mirror system. For example, the stored image can be presented on all or part of the front panel reflective surface for viewing and/or perception (e.g., voice, media, etc.).

In yet another implementation, a mirror system is disclosed, comprising: a housing having an internal volume within a front panel and a back panel, long side panels, and short side panels, the front panel comprises a reflective surface which functions as a mirror to an object positioned outside the internal volume and in front of the front panel; an imaging system mounted within the housing for capturing an image of the object via an aperture of the front panel, the imaging system operating according to instructions for configuring, capturing, transmitting, and storing the image; an aperture in the front panel through which the imaging system captures the image of the object; and a data connection for transmission of at least the image from the imaging system and storage of the image in an external storage.

The imaging system is part of cellular phone, which cellular phone is manually inserted in the housing and the imaging system of the cellular phone is installed in alignment with the aperture, and wherein user commands received by the cellular phone are processed to operate the imaging system of the phone. Operation of the imaging system can be automated, such as execution is in response to at least one of a user gesture or detection of the object. The imaging system can employ volatile memory wherein a captured image and related metadata is immediately transmitted from the imaging system to a remote storage location, and then erased from the imaging system.

In still another implementation, a mirror system is disclosed, comprising: a housing having an internal volume within a front panel and a back panel, long side panels, and short side panels, the front panel comprises a reflective surface which functions as a mirror to an object positioned outside the internal volume and in front of the front panel; an imaging system mounted within the housing for capturing an image of the object via an aperture of the front panel, the imaging system operating according to instructions for configuring, capturing, transmitting, and storing the image; an aperture in the front panel through which the imaging system captures the image of the object; and a data connection for transmission of at least the image and metadata from the imaging system, and storage of the image in an external storage.

The imaging system retrieves a previously stored image from a remote device and presents the image for viewing via the mirror system. The mirror system can further comprise a presentation system, which presents media on all or part of the front panel, and with which media a user can interact.

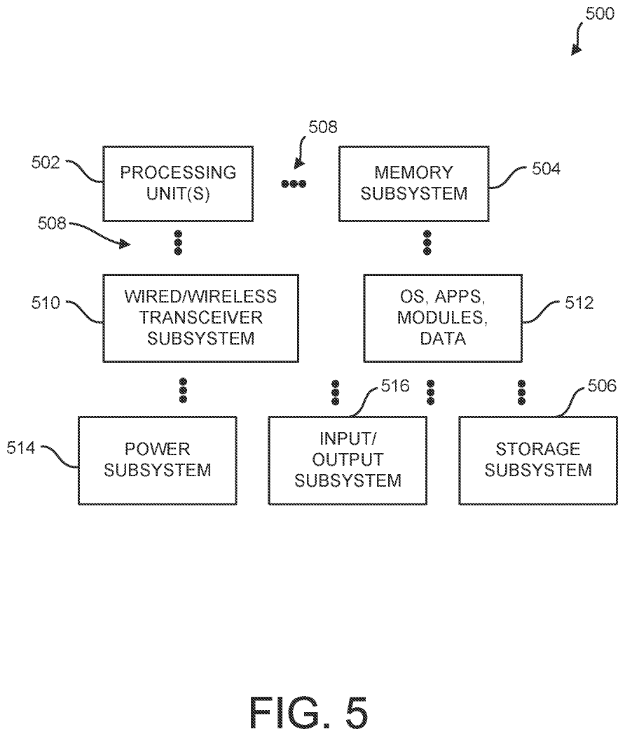

Referring now to FIG. 5, there is illustrated a block diagram of a computing system 500 capable of interfacing to and processing smart mirror data and settings in accordance with the disclosed architecture. As indicated above, it is to be appreciated, however, that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computing systems, those skilled in the art will recognize that a novel implementation also can be realized in combination with other program modules and/or as a combination of hardware and software.

The system 500 for implementing various aspects includes (micro)processing unit(s) 502 (also referred to as microprocessor(s) and processor(s)), a memory subsystem 504 comprising a computer-readable storage medium such as a system memory and a storage subsystem 506 (computer readable storage medium/media also include magnetic disks, optical disks, solid state drives, external memory systems, and flash memory drives), and a bus system 908 (denoted using ellipsis . . . ). The processing unit(s) 502 can be any of various commercially available microprocessors such as single-processor, multi-processor, single-core units and multi-core units of processing and/or storage circuits.

The system 500 can be employed in support of cloud access and computing services. Cloud computing services, include, but are not limited to, infrastructure as a service, platform as a service, software as a service, storage as a service, desktop as a service, data as a service, security as a service, and APIs (application program interfaces) as a service, for example.

The memory subsystem 504 can include computer-readable storage (physical storage) medium such as a volatile (VOL) memory (e.g., random access memory (RAM), static RAM for caching, etc.) and a non-volatile memory (NON-VOL) (e.g., ROM, EPROM, EEPROM, etc.), for example. A basic input/output system (BIOS) can be stored in the non-volatile memory, and includes the basic routines that facilitate the communication of data and signals between components within the system 500, such as during startup.

The bus system 508 provides an interface for system components including, but not limited to, the memory subsystem 504 to the processing unit(s) 502, and any wire/metal track interconnectivity between all modules such as a wired/wireless transceiver subsystem 510, operating system (OS) applications (Apps), software modules, and data components 512, a power subsystem 514 that provides power to all subsystems and components, and an I/O (input/output) subsystem 516 which includes all sensors (e.g., microphone, temperature, humidity, geolocation, level, pressure, and so on) and the electronics to operate and return data therefrom. The bus system 508 can be any of several types of commercially available bus architectures.

The power subsystem 514 can comprise technologies such as solely a battery system (where the user replaces batteries when discharged below a minimum power level), solely a utility outlet power (e.g., the soft product can be plugged into grid voltage such as 120 VAC to charge onboard batteries and/or operate solely on grid power), an induction technology where the user simply places the soft product proximate an induction plate to couple charging power into the onboard battery subsystem, or any combination of these power technologies. The power subsystem 514 can also receive power via a portable solar power system that can connect to the OCS (e.g., via a USB connector) and power the OCS subsystems of the soft product when away from grid power, such as at the beach or lake, for example.

The system 500 can further include machine readable storage subsystem(s) 506 (and storage interface(s)) for interfacing the storage subsystem(s) 506 to the bus system 508, and other desired components and circuits. The storage subsystem(s) 506 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) included as part of the storage subsystem 506 can include commonly available interface technologies such as EIDE, ATA, SATA, and IEEE 1394, for example.

Although shown as separate blocks, one or more application programs, program data, OS, and other software modules of block 512 can be stored in the memory subsystem 504, a machine readable and removable memory subsystem (e.g., flash drive form factor technology), and/or the storage subsystem(s) 506 (e.g., optical, magnetic, solid state).

Generally, programs include routines, methods, data structures, other software components, etc., that perform particular tasks, functions, or implement particular abstract data types. All or portions of the operating system, applications, modules, and/or data in block 512 can also be cached in memory such as volatile memory and/or non-volatile memory of the memory subsystem 504, for example.

The storage subsystem 506 and memory subsystem 504 serve as computer readable media for volatile and non-volatile storage of data, data structures, computer-executable instructions, and so on. Such instructions, when executed by a computer or other machine, can cause the computer or other machine to perform one or more acts of a method.

Computer-executable instructions comprise, for example, instructions and data which cause a general-purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the system 500, and include volatile and non-volatile internal and/or external media that is removable and/or non-removable. The various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods and processes of the disclosed architecture.

A user can interact with the programs and data using external user input devices as part of the I/O subsystem 516 such as a keyboard and a mouse, as well as by voice commands facilitated by speech and image recognition. Other external user input devices (sensors) can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the programs and data using user input devices such a touchpad, microphone, keyboard, etc., where desired, for example.

These and other input devices are connected to the processing unit(s) 502 through input/output (I/O) subsystem 516 via the bus system 508, but can be connected by other interfaces such as a parallel port, IEEE 1394 serial port, a game port, a USB port, an IR interface, short-range wireless (e.g., Bluetooth) and other personal area network (PAN) technologies, etc. The I/O subsystem 516 also facilitates the use of output peripherals such as printers, audio devices, camera devices, and so on, such as a sound card and/or onboard audio processing capability.

The I/O subsystem 516 can comprise one or more graphics interface(s) (also commonly referred to as a graphics processing unit (GPU)) provide graphics and video signals on a display and/or external display(s) (e.g., LCD, plasma) and/or onboard displays (e.g., for portable computer). The graphics interface(s) can also be manufactured as part of a system board.

The system 500 can operate in a networked environment (e.g., IP-based) using logical connections via the wired/wireless transceiver communications subsystem 510 to one or more networks and/or other devices or computers. The other computers can include workstations, servers, routers, personal computers, microprocessor-based entertainment appliances, peer devices or other common network nodes. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, mesh networks and mesh nodes, all of which may connect to a global communications network such as the Internet.

When used in a networking environment the system 100 connects to the network via a wired/wireless transceiver communication subsystem 510 (e.g., a network interface adapter, onboard transceiver subsystem, etc.) to communicate with wired/wireless networks, wired/wireless printers, wired/wireless input devices, and so on. The transceiver subsystem 510 can include a modem or other means for establishing communications over the network.

In a networked environment, programs and data can be stored in the remote memory/storage device, as is associated with a distributed system. It will be appreciated that the network connections shown are exemplary and other means of establishing a communications link between the computers can be used.

The system 500 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), telephones, cell phones, smart phones and smart devices (e.g., smart TVs), for example. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mirror system, comprising:
a housing having an internal volume within a front panel and a back panel, long side panels, and short side panels, the front panel comprises a reflective surface which functions as a mirror to an object positioned outside the internal volume and in front of the front panel;
an imaging system mounted within the housing for capturing an image of the object via an aperture of the front panel, the imaging system operating according to instructions for configuring, capturing, transmitting, and storing the image; and
a data connection for transmission of at least the image from the imaging system and storage of the image in an external storage.

2. The mirror system of claim 1, wherein the external storage is part of a cellular phone.

3. The mirror system of claim 1, wherein the data connection is at least one of wired or wireless capable.

4. The mirror system of claim 1, wherein the imaging system is part of a handheld camera that operates according to the instructions, and that can be installed and removed from the housing.

5. The mirror system of claim 1, wherein the imaging system is part of cellular phone, which cellular phone is manually inserted in the housing and the imaging system of the cellular phone is installed in alignment with the aperture.

6. The mirror system of claim 5, wherein user commands received by the cellular phone are processed to operate the imaging system of the phone as the instructions.

7. The mirror system of claim 1, wherein operation of the imaging system is automatically executed in response to at least one user gesture.

8. The mirror system of claim 1, wherein the imaging system is automatically triggered in response to detection of the object.

9. The mirror system of claim 1, wherein the imaging system employs volatile memory wherein a captured image is immediately transmitted from the imaging system to a remote storage location, and then erased from the imaging system.

10. The mirror system of claim 1, wherein the imaging system is controlled by a remote device to initiate image capture, which image capture further initiates creation of metadata related to the image capture, and transmission of the captured image and metadata to the remote device.

11. The mirror system of claim 1, wherein the imaging system retrieves a previously stored image from a remote device and presents the image for viewing via the mirror system.

12. The mirror system of claim 1, further comprising a presentation system, which presents media on all or part of the front panel, and with which media a user can interact.

13. The mirror system of claim 1, wherein part of the front panel functions as a heads-up display to present information to the user.

14. A mirror system, comprising:
a housing having an internal volume within a front panel and a back panel, long side panels, and short side panels, the front panel comprises a reflective surface which functions as a mirror to an object positioned outside the internal volume and in front of the front panel;
an imaging system mounted within the housing for capturing an image of the object via an aperture of the front panel, the imaging system operating according to instructions for configuring, capturing, transmitting, and storing the image;
an aperture in the front panel through which the imaging system captures the image of the object; and
a data connection for transmission of at least the image from the imaging system and storage of the image in an external storage.

15. The mirror system of claim 14, wherein the imaging system is part of cellular phone, which cellular phone is manually inserted in the housing and the imaging system of the cellular phone is installed in alignment with the aperture, and wherein user commands received by the cellular phone are processed to operate the imaging system of the phone.

16. The mirror system of claim 14, wherein operation of the imaging system is executed in response to at least one of a user gesture or detection of the object.

17. The mirror system of claim 14, wherein the imaging system employs volatile memory wherein a captured image and related metadata is immediately transmitted from the imaging system to a remote storage location, and then erased from the imaging system.

18. A mirror system, comprising:
a housing having an internal volume within a front panel and a back panel, long side panels, and short side panels, the front panel comprises a reflective surface which functions as a mirror to an object positioned outside the internal volume and in front of the front panel;
an imaging system mounted within the housing for capturing an image of the object via an aperture of the front panel, the imaging system operating according to instructions for configuring, capturing, transmitting, and storing the image;
an aperture in the front panel through which the imaging system captures the image of the object; and
a data connection for transmission of at least the image and metadata from the imaging system, and storage of the image in an external storage.

19. The mirror system of claim 18, wherein the imaging system retrieves a previously stored image from a remote device and presents the image for viewing via the mirror system.

20. The mirror system of claim 18, further comprising a presentation system, which presents media on all or part of the front panel, and with which media a user can interact.
